(19) United States
(12) Patent Application Publication
(10) Pub. No.: US 2015/0050881 A1
(43) Pub. Date: Feb. 19, 2015

(54) WIRELESS POWER CHARGER

(71) Applicant: Quanta Computer Inc., Taoyuan Shien (TW)

(72) Inventors: Pei-Heng CHEN, Taoyuan County (TW); Liang-Fu CHEN, Taoyuan County (TW)

(73) Assignee: QUANTA COMPUTER INC., Taoyuan Shien (TW)

(21) Appl. No.: 14/190,872

(22) Filed: Feb. 26, 2014

(30) Foreign Application Priority Data
Aug. 13, 2013 (TW) 102129001

(51) Int. Cl. H04W 52/02; H04B 5/00; H02J 7/00

(52) U.S. Cl. CPC H04W 52/0296; H02J 7/0004; H04B 5/0037
USPC 455/41.1; 455/573

(57) ABSTRACT

The invention provides a wireless power charger comprising a wireless and a power bank. The wireless charging base including a wireless transmitter configured to transmit an identification signal. The power bank is electrically connected to a portable device including a first rechargeable battery, and the power bank including a second rechargeable battery, a wireless receiver, and a control unit. The wireless receiver is configured to receive the identification signal and transmit a response signal to the wireless transmitter while the power bank is placed onto the wireless charging base. The control unit is configured to control and output the power to the first rechargeable battery or the second rechargeable battery.

### RELATED APPLICATIONS

This application claims priority to Taiwan Application Serial Number 102129001, filed Aug. 13, 2013, which is herein incorporated by reference.

### BACKGROUND

1. Field of Invention

The present invention relates to a wireless power charger.

2. Description of Related Art

With the advancement of technology, smart devices and mobile electronic products have been widely accepted in the market. Particularly, smart phones have gradually been taking the replacement of conventional cellular phones. However, the smart phones that equipped with large screen and multi-tasks computation are power consuming and therefore inconvenient as the mobile electronic products for users. To solve the problem, a user may connect a smart device to a mobile power supply while going out, so as not to run out of battery. However, a conventional mobile power supply has to collaborate with a power cable particularly adaptable for the smart device; otherwise, the device can only be charged by the power charger, which is inconvenient to a user.

### SUMMARY

The invention provides a wireless power charger comprising a wireless and a power bank. The wireless charging base including a wireless transmitter configured to transmit an identification signal. The power bank is electrically connected to a portable device including a first rechargeable battery, and the power bank including a second rechargeable battery, a wireless receiver, and a control unit. The wireless receiver is configured to receive the identification signal and transmit a response signal to the wireless transmitter while the power bank is placed onto the wireless charging base. The control unit is configured to control and output the power to the first rechargeable battery or the second rechargeable battery.

The invention provides a wireless charging method comprising the steps of: (a) utilizing a wireless transmitter of a wireless charging base to transmit an identification signal; (b) utilizing a wireless receiver of a power bank to receive the identification signal and transmit a response signal while the power bank is placed on the wireless charging base; (c) managing and outputting the power to a first rechargeable battery of a portable device or a second rechargeable battery of the power bank.

The wireless power charger of the invention provides users a more convenient choice of charging. When a user is charging, the user does not need to choose to charge the portable device first or to charge the power bank first. Besides, the invention avoids the problem of cords winding; therefore, the module of the invention is integrated with simple and beauty. At last, the wireless power charger integrates the identification and communication mechanism. The mechanism integrates the function of automatically calculating the charging efficiency, increases the safety and the lifetime of the wireless charging method, and avoids the thermal effect caused by that a metal product absorbs a wireless power, so that the electric device avoids to be burned and damaged.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of the wireless power charger according to one embodiment of the present invention;

FIG. 2 illustrates the wireless charging base according to one embodiment of the present invention;

FIG. 3 illustrates the power bank according to one embodiment of the present invention;

FIG. 4 is a perspective view of the power bank charging the portable device;

FIG. 5 illustrates that the wireless charging base charges the power bank;

FIG. 6 is a block diagram of the wireless power charger;

FIG. 7 is a flow chart of the identification mechanism of the present invention;

FIG. 8 is a graph of the identification signal to one embodiment of the present invention; and

FIG. 9 is a graph of the response signal to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

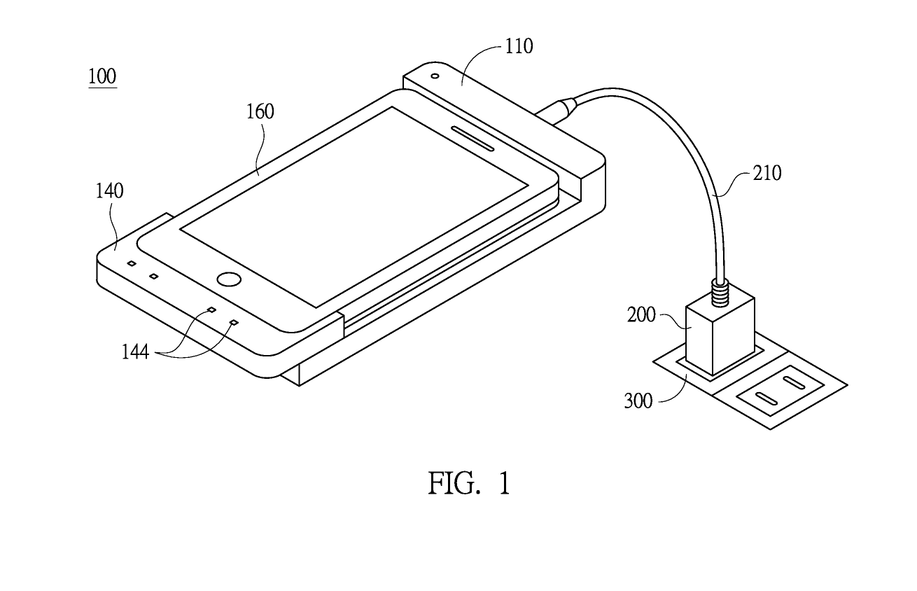

In order to solve the problem that conventional power charging device is inconvenient to users, the presented invention provides a wireless power charger 100. FIG. 1 is a perspective view of the wireless power charger 100 according to one embodiment of the present invention. The wireless power charger 100 includes a wireless charging base 110 and a power bank 140. According to an aspect of the invention, users only need to connect the power bank 140 and the portable device 160 (for example, a mobile phone or a tablet computer), so that the power bank 140 can charge the portable device 160. According to another aspect of the invention, when the power bank 140 is electrically connected to the portable device 160, users can put the power bank 140 with the portable device 160 on the wireless charging base 110, so that the power bank 140 and the portable device 160 can be charged. According to another aspect of the invention, users can merely put the power bank 140 on the wireless charging base 110, so that the power bank 140 can be charged.

The wireless power charger 100 of the invention integrates a portable power and wireless charging technique (by integrating the power bank 140 and the wireless charging base 110) and users can choose a charging method according to their actual needs. For instance, when a user is out of a building, one can charge his portable device by the power bank 140. When a user is in a building, one can use the wireless charging base 110 to charge the portable device 160 and/or the power bank 140, hence, the usage convenience is improved.

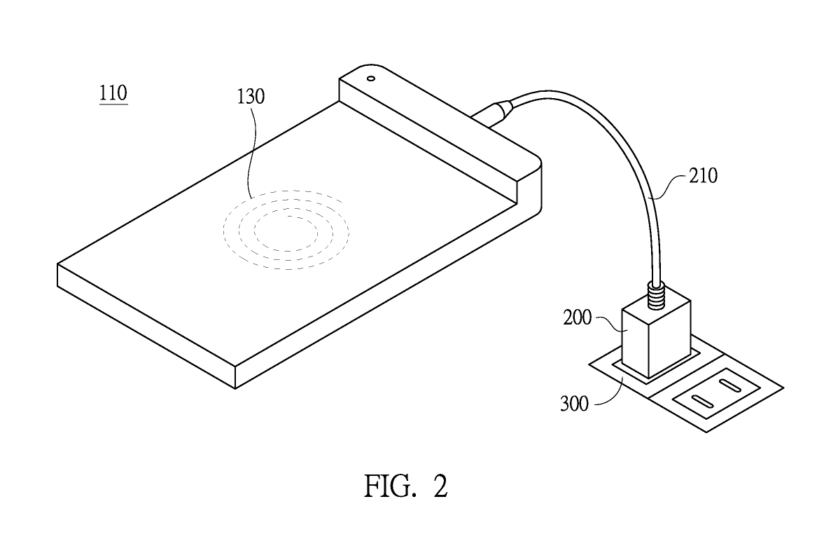

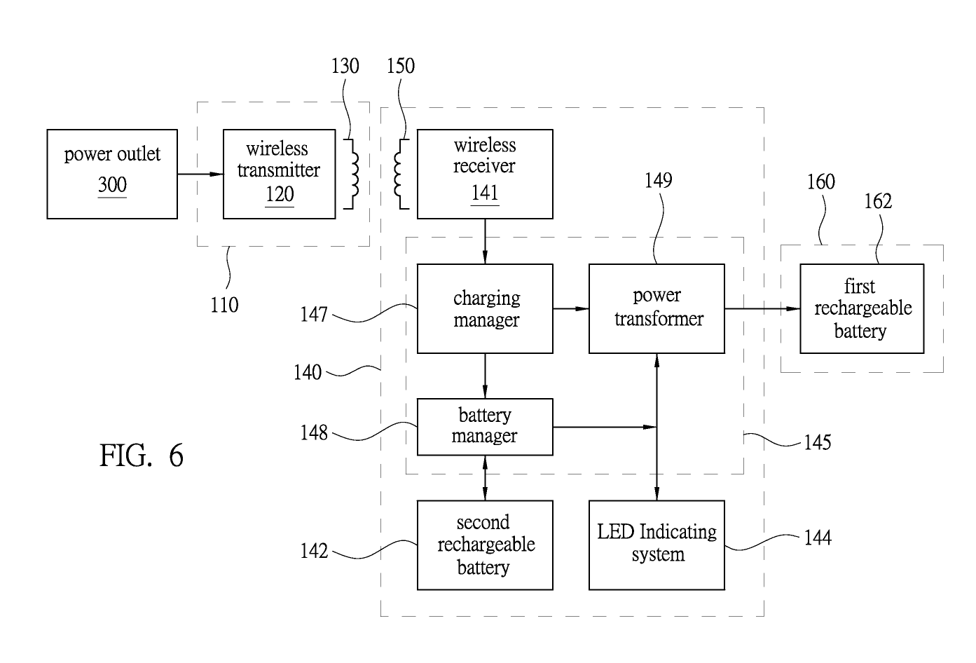

FIG. 2 illustrates the wireless charging base 110 according to one embodiment of the present invention. The wireless charging base 110 includes the wireless transmitter 120(referring to FIG. 6), a first Induction coil 130, a power cord 210, and a plug 200. The plug 200 and the power cord 210 transmit power provided from a power outlet 300, so the portable device 160 and the power bank 140 can be charged. Specifically, the plug 200 of the wireless charging base 110 transmits the power through the power cord 210 to the first Induction coil 130. Thus, an induced magnetic field is generated by means of the first Induction coil 130 receiving the power; therefore, the wireless power supplying can be functioned. The wireless transmitter 120 is configured to transmit the identification signal and to receive the response signal from the power bank 140 or the portable device 160 so as to determine whether wirelessly transmitting power or not when the portable device 160 and/or the power bank 140 are put on the wireless charging base 110.

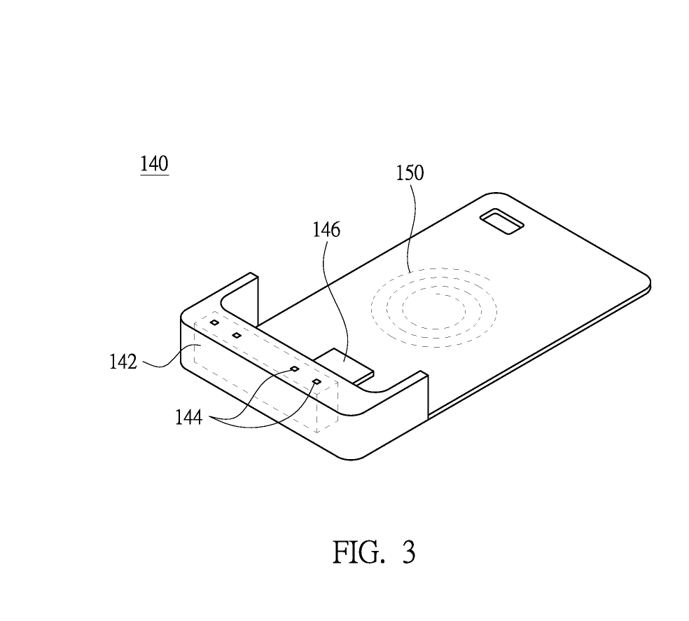

FIG. 3 illustrates the power bank according to one embodiment of the present invention. The power bank 140 includes a second rechargeable battery 142 and a second Induction coil 150. When the induced magnetic field transmitted by the first Induction coil 130 passes through the second Induction coil 150, the second Induction coil 150 generates power. In the meantime, the power bank 140 provides the power to charge the portable device 160 or/and the second rechargeable battery 142 inside of it. In addition, the power bank 140 further includes a LED Indicating system 144 and a connecting port 146. The LED Indicating system 144 is configured to indicate the charging status of the portable device 160 and the second rechargeable battery 142. The connecting port 146 is the electrical connecting interface used to engage with the portable device 160, so that the power can be charged into the portable device 160 through the connecting port 146.

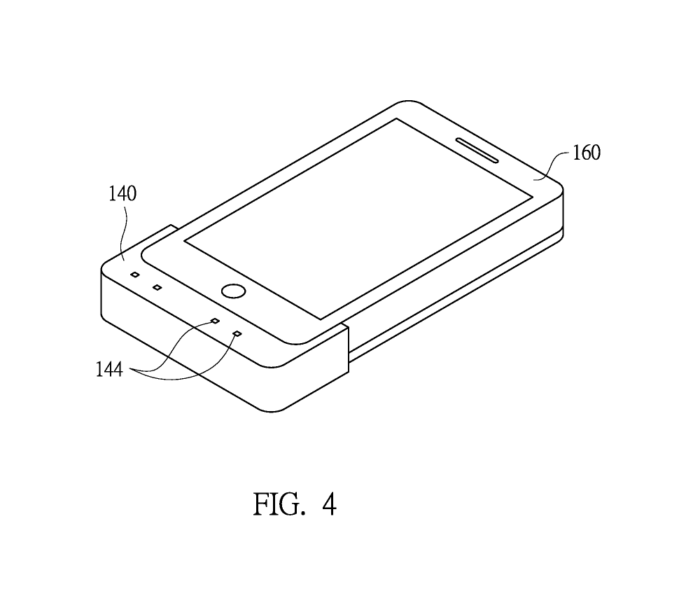

FIG. 4 is a perspective view of the power bank charging the portable device. While the power bank 140 is electrically connected to the portable device 160, the power bank 140 immediately utilizes the power of the second rechargeable battery 142 to charge the portable device 160. In an embodiment of the invention, once the portable device 160 is charged up to a predetermined electrical quantity, this charging process is suspended immediately, for instance, once the portable device 160 is charged up to 90% of fully charged, the charging process is suspended immediately. It should be noted that the invention is not limited by the example described above.

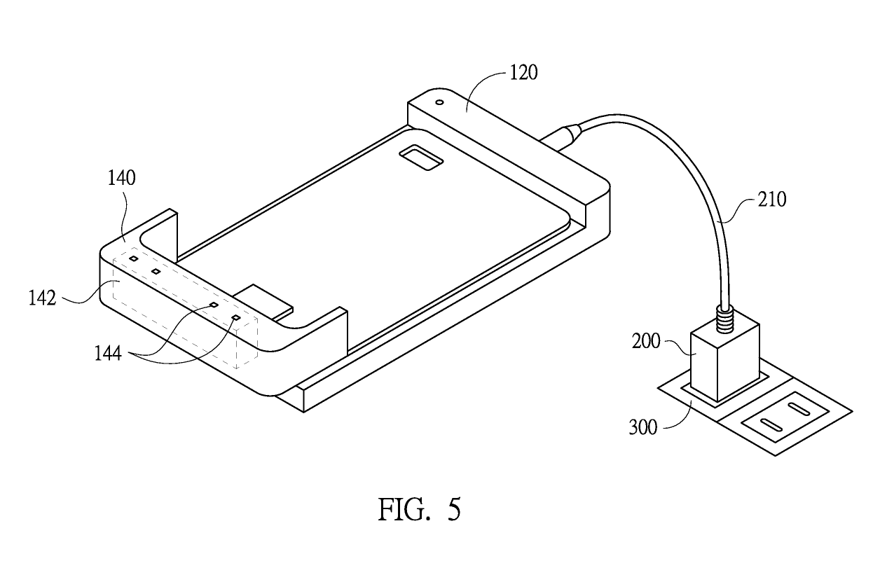

FIG. 5 illustrates that the wireless charging base charges the power bank. When the power bank 140 is placed onto the wireless charging base 110, the wireless charging base 110 can merely charge the power bank 140 and can avoid the inconvenience of connecting or disconnecting with a wire cord.

FIG. 6 is a block diagram of the wireless power charger. In view of the above, the wireless power charger 100 includes the wireless charging base 110 and the power bank 140. The wireless charging base 110 receives the power supplied by the power outlet 300. A wireless receiver 141 of the power bank 140 is configured to receive the identification signal from the wireless transmitter 120 of the wireless charging base 110, and to transmit the response signal (will be described later) to the wireless transmitter 120, so that the first Induction coil 130 of the wireless transmitter 120 generates the induced magnetic field, and after the magnetic flux of the induced magnetic field passes through the second Induction coil 150, the power is generated.

After the power is generated, the control unit 145 manages and outputs the power to the first rechargeable battery 162 or/and the second rechargeable battery 142 of the power bank 140 within the portable device 160. The control unit 145 includes the charging manager 147, a power transformer 149, and a battery manager 148. The charging manager 147 is electrically connected to the wireless receiver 141, and used to manage the charging sequence of the first rechargeable battery 162 and the second rechargeable battery 142. The power transformer 149 is electrically connected to the charging manager 147, and used to convert the power to a charging voltage suitable for the portable device 160 while charging the first rechargeable battery 162, thus, the portable device 160 can receive the suitable charging voltage to charge the first rechargeable battery 162. The battery manager 148 is electrically connected to the charging manager 147, used to charge the second rechargeable battery 142 instead if the charging manager 147 determines the electrical quantity of the first rechargeable battery 162 is up to the predetermined electrical quantity. Besides, the battery manager 148 can detect the voltage status of the second rechargeable battery 142 to determine the status of the second rechargeable battery 142 is under charging process, losing power, charged up to the predetermined electrical quantity or not working, etc. The battery manager 148 also transmits the current status to the LED Indicating system 144 to indicate corresponded lighting mode, for example, to display different color or change flashing frequency.

In one embodiment of the invention, the charging manager 147 and the battery manager 148 can be integrated in one chip. In another embodiment of the invention, the charging manager 147, the power transformer 149, and the battery manager 148 can be integrated in one chip.

In one embodiment of the invention, the control unit 145 charges the first rechargeable battery 162 first, and then charges the second rechargeable battery 142. Specifically, as the charging manager 147 allocates the power to the first rechargeable battery 162 or the second rechargeable battery 142, while the first rechargeable battery 162 is not charged up to the predetermined electrical quantity, the charging manager 147 allocates the power into the power transformer 149, then the power transformer 149 converts and rectifies the power into the charging voltage that can be utilized. Therefore, the portable device 160 is not damaged even if the power is suddenly changed or the charging voltage is not utilizable. When the portable device 160 is charged up to the predetermined electrical quantity or is not electrically connected to the portable device 160(referring to FIG. 5), the charging manager 147 can determine whether the second rechargeable battery 142 is charged up to the predetermined electrical quantity or not by the battery manager 148. If not, the charging manager 147 allocates the power to the second rechargeable battery 142. As the portable device 160 and the second rechargeable battery 142 are charged up to the predetermined electrical quantity, the wireless power charger 100 stop charging.

Please refer to FIG. 4. As the power bank 140 is electrically connected to the portable device 160 but is not put onto the wireless charging base 110, the second rechargeable battery 142 of the power bank 140 converts the power into the charging voltage to charge the portable device 160 through the battery manager 148 and the power transformer 149 until the portable device 160 is charged up to the predetermined electrical quantity.

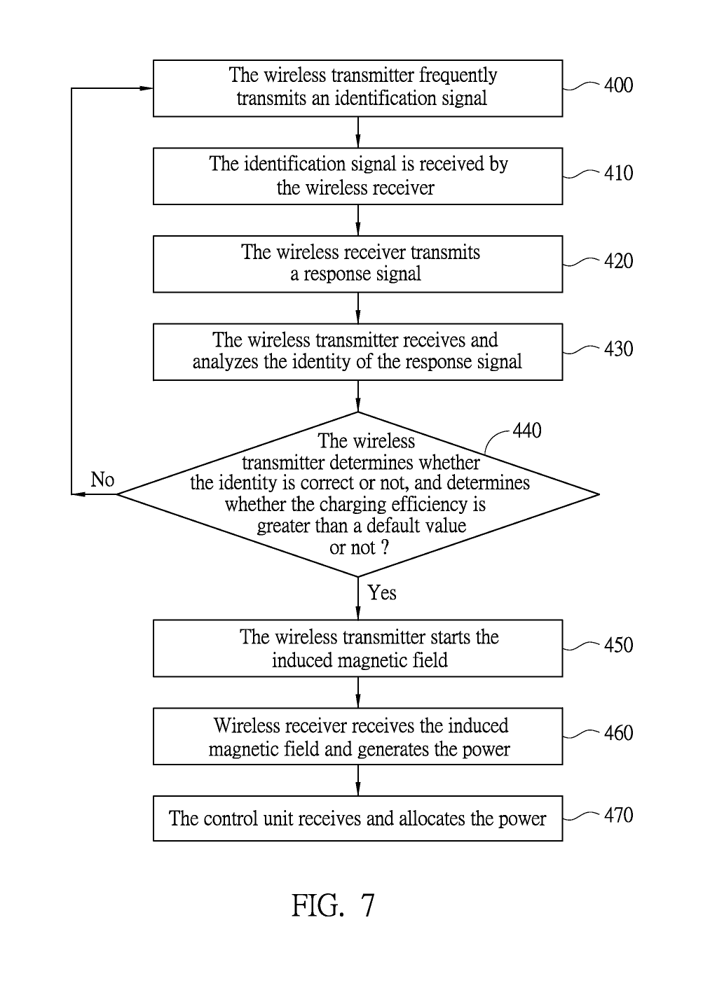

FIG. 7 is a flow chart of the identification mechanism of the present invention. FIG. 7 disclosed the identification mechanism between the wireless transmitter 120 and the wireless receiver 141. At first, in the step 400, the wireless transmitter 120 frequently transmits an identification signal 500 that records an identification of the wireless transmitter 120. In the step 410, the identification signal 500 is received by the wireless receiver 141. In the step 420, the wireless receiver 141 transmits a response signal 520. The response signal 520 includes an identity and a current flow value of charging efficiency. In the step 430, the wireless transmitter 120 receives and analyzes the identity of the response signal 520 and the current flow value of the charging efficiency. In the step 440, the wireless transmitter 120 determines whether the identity is correct or not, and determines whether the charging efficiency is greater than a default value or not. When the wireless transmitter 120 determines the identity is not correct or the charging efficiency is lower than the default value, it manifests that an object put on the wireless transmitter 120 is unauthenticated and is not chargeable. Then the process returns to step 400, the wireless transmitter 120 continues to transmit the identification signal 500 frequently and the identification mechanism is restarted. To perform step 440 is owing to a safety concern. Specifically, if the object put on the wireless transmitter 120 is an iron matter without a coil, the charging efficiency would be lower than the default value, so that the wireless transmitter 120 can determine that the object is not the chargeable power bank 140 and don't perform charging process. If the object put on the wireless transmitter 120 is a power bank manufactured by third part, the power bank can't transmit correct identity or can't even transmit a response signal to the wireless receiver 141. Therefore, the power bank can be determined to be an unauthenticated one and the charging process is not performed to avoid error functioning, for example, to supply a wrong voltage causing damage.

In one embodiment of the present invention, the default value of the charging efficiency, for example, is sixty percent. In one embodiment of the present invention, the wireless transmitter 120 and the wireless receiver 141 can perform transmitting and receiving.

When the identity is correct and the charging efficiency is higher than the default value, then process into step 450. In the meanwhile, the wireless transmitter 120 starts the induced magnetic field to perform the wireless power transmitting. In the step 460, after the wireless receiver 141 receives the induced magnetic field, the wireless receiver 141 generates the power and transmits the power into the control unit 145. In the step 470, the control unit 145 receives and allocates the power to charges the portable device 160 or the second rechargeable battery 142.

FIG. 8 is a graph of the identification signal to one embodiment of the present invention. In this figure, the horizontal axis is time t, the vertical axis is voltage v. The wireless transmitter 120 of the wireless charging base 110 transmits the identification signal 500. The identification signal 500 includes a plurality of the first pulses 510 that record the identity of the wireless transmitter 120.

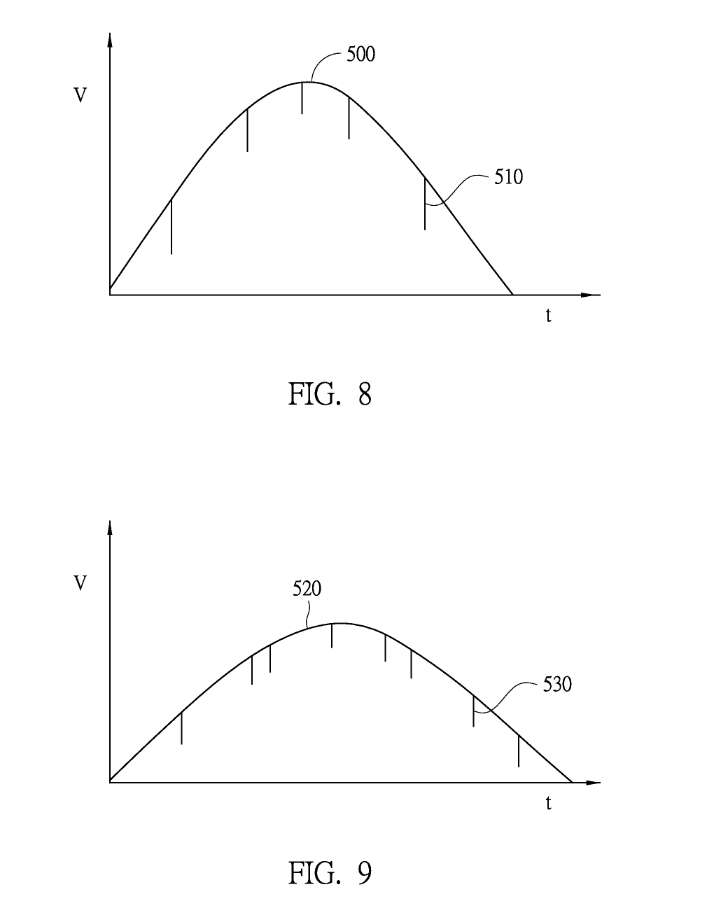

FIG. 9 is a graph of the response signal to one embodiment of the present invention. In this figure, the horizontal axis is time t, the vertical axis is voltage v. When the power bank 140 is placed onto the wireless charging base 110, the wireless receiver 141 receives the identification signal 500 from the wireless transmitter 120 and transmits the response signal 520. The wireless receiver 141 generates the response signal 520 according to the plurality of the first pulses 510, where the response signal 520 includes a plurality of the second pulses 530 that record the identity of the wireless receiver 141 and are related to a current flow of a charging efficiency. After the wireless transmitter 120 receives the response signal 520, determining the identity and calculating the charging efficiency by the current flow. When the wireless transmitter 120 identifies the identity and determines that the charging efficiency is greater than the default value, the wireless transmitter 120 starts the induced magnetic field, and eventually, the charging process is initiated.

The wireless power charger of the invention provides users a more convenient choice of charging. When a user is charging, the user does not need to choose to charge the portable device first or to charge the power bank first. Because the wireless power charger can charge the portable device up to the predetermined electrical quantity, and then switches to charge the power bank automatically. Besides, the invention avoids the problem of cords winding; therefore, the module of the invention is integrated with simple and beauty. At last, the wireless power charger integrates the identification and communication mechanism, where the mechanism demands that the wireless transmitter and the power bank have to match with each other to initiate the charging process. That is to say, even different wireless charge devices are placed together, and the voltage requirement is different, there is no safety concern. The mechanism integrates the function of automatically calculating the charging efficiency, increases the safety and the lifetime of the wireless charging method, and avoids the thermal effect caused by that a metal product absorbs a wireless power, so that the electric device avoids to be burned and damaged.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless power charger comprising:
a wireless charging base including a wireless transmitter configured to transmit an identification signal; and
a power bank electrically connected to a portable device including a first rechargeable battery, and the power bank including:
a second rechargeable battery;
a wireless receiver configured to receive the identification signal and transmit a response signal to the wireless transmitter while the power bank is placed onto the wireless charging base; and
a control unit configured to control and output power to the first rechargeable battery or the second rechargeable battery.

2. The wireless power charger of claim 1, wherein the identification signal includes a plurality of first pulses recording an identity of the wireless transmitter, and the wireless receiver is based on the first pulses to generate the response signal, wherein the response signal includes a plurality of second pluses that record an identity of the wireless receiver and are related to a charging efficiency, and the wireless transmitter provides the power to the wireless receiver while determining that the charging efficiency is greater than a default value.

3. The wireless power charger of claim 2, wherein the control unit further comprises:
a charging manager electrically connected to the wireless receiver, and configured to manage a charging sequence of the first rechargeable battery and the second rechargeable battery; and
a power transformer electrically connected to the charging manager, and configured to transform the power into a charging voltage suitable for the portable device when the charging manger set the first rechargeable battery to be charged first.

4. The wireless power charger of claim 3, wherein the control unit further comprises:
a battery manager electrically connected to the charging manager, and configured to charge the second rechargeable battery while the charging manager determines that an electrical quantity of the first rechargeable battery is equal to or greater than a predetermined electrical quantity.

5. The wireless power charger of claim 1, wherein the portable device is a mobile phone or a tablet computer.

6. A wireless charging method comprising the steps of:
(a) utilizing a wireless transmitter of a wireless charging base to transmit an identification signal;
(b) utilizing a wireless receiver of a power bank to receive the identification signal and transmit a response signal while the power bank is placed on the wireless charging base; and
(c) managing and outputting power to a first rechargeable battery of a portable device or a second rechargeable battery of the power bank.

7. The wireless charging method of claim 6, wherein the step (a) comprises: generating the identification signal including a plurality of first pulses that record an identity of the wireless transmitter; the step (b) comprises: controlling the wireless receiver to generate the response signal based on the first pulses, where the response signal including a plurality of second pulses that record an identity of the wireless receiver and a charging efficiency, and the wireless transmitter provides the power to the wireless receiver while determining that the charging efficiency is greater than a default value.

8. The wireless charging method of claim 7, wherein the step (c) comprises:
managing a charging sequence of first and second rechargeable batteries; and
transforming the power into a charging voltage suitable for the portable device when the first rechargeable battery is set to be charged first according to the charging sequence.

9. The wireless charging method of claim 8, wherein the step (c) further comprises:
charging the second rechargeable battery when an electrical quantity of the first rechargeable battery is equal to or greater than a predetermined electrical quantity.

10. The wireless charging method of claim 6, wherein the portable device is a mobile phone or a tablet computer.
